(19) United States
(12) Patent Application Publication
(10) Pub. No.: US 2015/0037536 A1
(43) Pub. Date: Feb. 5, 2015

(54) RELEASE FILM FOR CERAMIC GREEN SHEET PRODUCTION PROCESS

(71) Applicant: LINTEC CORPORATION, Tokyo (JP)

(72) Inventors: Tomomi Fukaya, Tokyo (JP); Shinya Ichikawa, Tokyo (JP)

(21) Appl. No.: 14/387,559

(22) PCT Filed: Feb. 4, 2013
(86) PCT No.: PCT/JP2013/052491

§ 371 Date: Sep. 24, 2014

(30) Foreign Application Priority Data
Mar. 28, 2012 (JP) 2012-073680

(51) Int. Cl. B32B 27/28; B32B 27/30; B32B 3/00

(52) U.S. Cl. CPC B32B 27/283; B32B 3/00; B32B 27/308; B32B 2250/02; B32B 2270/00; B32B 2305/77; B32B 2307/732
USPC 428/141

(57) ABSTRACT

A release film for a ceramic green sheet production process is provided. The release film comprises a base material and a release agent layer provided at one side of the base material. The release agent layer comprises a cured material of a release agent composition. The release agent composition contains an active energy ray curable component and a silicone-based component. A surface of the release agent layer at the opposite side to the base material has an arithmetic average roughness (Ra) of 8 nm or less and a maximum projection height (Rp) of 50 nm or less. According to the release film for a ceramic green sheet production process, it is possible to effectively prevent/suppress the occurrence of defects such as pinholes and thickness irregularity in a ceramic green sheet, and the releasability of a ceramic green sheet is also excellent.

### TECHNICAL FIELD

The present invention relates to a release film that is used in a production process of a ceramic green sheet.

### BACKGROUND ART

To produce multi-layer ceramic products such as multi-layer ceramic capacitors and multi-layer ceramic substrates, it has conventionally been performed to mold ceramic green sheets and laminate the obtained plural ceramic green sheets to be fired.

A ceramic green sheet is molded by coating a release film with ceramic slurry that contains ceramic materials such as barium titanate and titanium oxide. As the release film, a film base material treated for release with silicone-based compound such as polysiloxane may be used.

Such a release film is required to have releasability such that a thin ceramic green sheet molded on the release film can be released from the release film without breakage and other troubles.

In recent years, as electronic devices are reduced in size and enhanced in performance, the multi-layer ceramic capacitors and multi-layer substrates are also reduced in size and increased in the number of lamination, so that the ceramic green sheet is more and more reduced in its thickness. If the ceramic green sheet is reduced in thickness and the thickness after drying becomes 3 μm or less, for example, defects such as pinholes and thickness irregularity may readily occur in the ceramic green sheet when the ceramic slurry is coated and dried. In addition, when the molded ceramic green sheet is released from the release film, troubles may readily occur such as breakage of the ceramic green sheet due to reduction in its strength.

To solve the former problem, Patent Literature 1 proposes to use a carrier film (release film) having a surface to which ceramic slurry is applied and of which a maximum height Rmax as defined by JIS B0601 is 0.2 μm or less.

### PRIOR ART LITERATURE

### Patent Literature

[Patent Literature 1] JP2003-203822A

### SUMMARY OF THE INVENTION

### Problems to be Solved by the Invention

However, even when a release film having a defined maximum height Rmax as in Patent Literature 1 is used, it may not be possible to effectively prevent the occurrence of defects such as pinholes and thickness irregularity in a ceramic green sheet having a reduced thickness. In addition, when a ceramic green sheet having a reduced thickness is released from the release film, troubles such as breakage of the ceramic green sheet may still occur.

The present invention has been made in consideration of such actual circumstances, and an object of the present invention is to provide a release film for a ceramic green sheet production process which can prevent/suppress the occurrence of defects such as pinholes and thickness irregularity in a ceramic green sheet and which has excellent releasability of a ceramic green sheet.

### Means for Solving the Problems

To achieve the above object, first, the present invention provides a release film for a ceramic green sheet production process, the release film being characterized by comprising a base material and a release agent layer provided at one side of the base material, wherein the release agent layer comprises a cured material of a release agent composition that contains an active energy ray curable component and a silicone-based component, and a surface of the release agent layer at an opposite side to the base material has an arithmetic average roughness (Ra) of 8 nm or less and a maximum projection height (Rp) of 50 nm or less (Invention 1).

According to the above invention (Invention 1), the surface of the release agent layer is highly smooth mainly due to the cured material of the active energy ray curable component. Therefore, it is possible to effectively prevent/suppress the occurrence of defects such as pinholes and thickness irregularity in a ceramic green sheet. In addition, the releasability from a ceramic green sheet is also excellent due to the silicone-based component or its cured material.

In the above invention (Invention 1), it is preferable that an area occupation ratio of coarse protrusions is 10% or less, wherein the coarse protrusions have a projection height of 10 nm or more at the surface of the release agent layer at the opposite side to the base material (Invention 2).

In the above invention (Inventions 1, 2), it is preferable that the silicone-based component comprises polyorganosiloxane having a reactive functional group (Invention 3).

In the above invention (Inventions 1 to 3), it is preferable that a mass fraction of the silicone-based component in the release agent composition to a total mass of the active energy ray curable component and the silicone-based component is 0.7 to 5 mass % (Invention 4).

In the above invention (Inventions 1 to 4), it is preferable that the active energy ray curable component comprises (meth)acrylic ester (Invention 5).

In the above invention (Invention 5), it is preferable that the (meth)acrylic ester comprises trifunctional or more functional (meth)acrylic ester (Invention 6).

In the above invention (Inventions 1 to 6), it is preferable that the release agent layer has a thickness of 0.3 to 2 μm (Invention 7).

In the above invention (Inventions 1 to 7), it is preferable that a surface of the base material at an opposite side to the release agent layer has an arithmetic average roughness (Ra) of 5 to 50 nm and a maximum projection height (Rp) of 30 to 500 nm.

### Advantageous Effect of the Invention

According to the release film for the ceramic green sheet production process of the present invention, the surface of the release agent layer is highly smooth, so that it is possible to effectively prevent/suppress the occurrence of defects such as pinholes and thickness irregularity in a ceramic green sheet, and the releasability from a ceramic green sheet is also excellent.

### BRIEF DESCRIPTION OF DRAWING(S)

FIG. 1 is a cross-sectional view of a release film according to one embodiment of the present invention.

### EMBODIMENTS FOR CARRYING OUT THE INVENTION

Embodiments of the present invention will hereinafter be described.

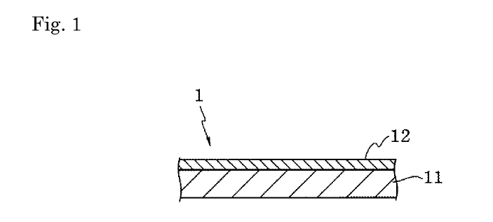

As shown in FIG. 1, a release film for a ceramic green sheet production process (which may be referred simply to as a “release film”, hereinafter) 1 according to the present embodiment comprises a base material 11 and a release agent layer 12 laminated on a first surface (the upper surface in FIG. 1) of the base material 11.

In the release film 1 according to the present embodiment, a surface of the release agent layer 12 (the upper surface in FIG. 1; the surface at the opposite side to the base material 11) on which ceramic slurry is to be molded has an arithmetic average roughness (Ra) of 8 nm or less and a maximum projection height (Rp) of 50 nm or less. The arithmetic average roughness (Ra) and the maximum projection height (Rp) as used herein refer to values measured in conformity with JIS B0601-1994 (in an exemplary test, measured using a surface roughness measuring machine SV3000S4 (stylus type) available from Mitutoyo Corporation).

By adjusting the arithmetic average roughness (Ra) and the maximum projection height (Rp) of the surface of the release agent layer 12 within such ranges as described above, the surface of the release agent layer 12 can sufficiently be highly smooth to exhibit good sheet moldability. For example, even when a thin film ceramic green sheet having a thickness of less than 1 μm is molded on the surface of the release agent layer 12, defects such as pinholes and thickness irregularity are unlikely to occur in the thin film ceramic green sheet. This excellent effect cannot be obtained merely by defining the maximum height (Rmax) of the release agent layer 12 as in Patent Literature 1.

The arithmetic average roughness (Ra) of the surface of the release agent layer 12 may preferably be 6 nm or less, and particularly preferably 4 nm or less. The maximum projection height (Rp) of the surface of the release agent layer 12 may preferably be 40 nm or less, and particularly preferably 30 nm or less.

An area occupation ratio of coarse protrusions having a projection height of 10 nm or more at the surface of the release agent layer 12 may preferably be 10% or less, particularly preferably 8.5% or less, and further preferably 7% or less. The area occupation ratio of coarse protrusions having a projection height of 10 nm or more as used herein refers to a ratio of a sum of areas of cut planes which appear when protrusions having a projection height of 10 nm or more are cut at a height of 10 nm parallel to the surface of the release agent layer 12, to an area of the surface of the release agent layer 12. The area occupation ratio of coarse protrusions in the present description may be calculated such that: observation is performed at ×50 magnitude in PSI mode using an optical interferometry-type surface profile observation apparatus (in an exemplary test, using “WYKO-1100” available from Veeco Instruments Inc.); thresholding is performed between parts having a projection height of 10 nm or more and other parts in the obtained surface profile image within a coverage of 91.2×119.8 μm; the parts having a projection height of 10 nm or more are assumed as cut planes which appear when protrusions having a projection height of 10 nm or more are cut at a height of 10 nm parallel to the surface of the release agent layer 12; and a fraction of the areas of the cut planes to the whole surface is calculated as a percentage.

If the release sheet is such that the above area occupation ratio of coarse protrusions exceeds 10%, there may be a risk that relatively high protrusions (e.g., protrusions having a height of about 40 to 50 nm) are present fairly infrequently. If the release sheet has an area occupation ratio of coarse protrusions of 10% or less, those relatively high protrusions are unlikely to be present. The ceramic green sheet obtained by using the release sheet is more effectively prevented/suppressed the occurrence of defects such as pinholes and thickness irregularity.

The base material 11 to be used in the release film 1 according to the present embodiment is not particularly limited, and may appropriately be selected from any of conventionally known ones. Examples of such base material 11 include films formed of plastic, such as polyethylene terephthalate, polyethylene naphthalate and other polyester, polypropylene, polymethylpentene and other polyolefin, polycarbonate, and ethylene-vinyl acetate copolymer, which may be a single layer, or may be multilayer of two or more layers of the same type or different types. Among them, polyester film is preferable, polyethylene terephthalate film is particularly preferable, and biaxial stretched polyethylene terephthalate film is further preferable. When being fabricated and used, polyethylene terephthalate film is unlikely to generate dust and the like, and can effectively prevent troubles, such as ceramic slurry coating failure, due to dust and the like, for example.

A first surface of the base material 11 may be subjected to surface treatment such as using oxidation method or primer treatment for the purpose of improving the interfacial adhesion with the release agent layer 12 to be provided on the first surface. Examples of the above oxidation method include corona discharge treatment, plasma discharge treatment, chromium oxidation treatment (wet type), flame treatment, hot-air treatment, ozone exposure treatment, and ultraviolet irradiation treatment. These surface treatment methods may be appropriately selected depending on the type of the base material film, and the corona discharge treatment method may preferably be used in view of the effect and the operability in general.

The thickness of the base material 11 may ordinarily be 10 to 300 μm, preferably 15 to 200 μm, and particularly preferably 20 to 125 μm.

An arithmetic average roughness (Ra) at the first surface of the base material 11 may preferably be 2 to 50 nm, and particularly preferably 5 to 30 nm. A maximum projection height (Rp) at the first surface of the base material 11 may preferably be 10 to 700 nm, and particularly preferably 30 to 500 nm. Adjusting the arithmetic average roughness (Ra) and the maximum projection height (Rp) at the first surface of the base material 11 within the above ranges may allow the arithmetic average roughness (Ra) and the maximum projection height (Rp) at the surface of the release agent layer 12 to easily fall within the previously-described ranges.

An arithmetic average roughness (Ra) at a second surface (surface at the opposite side to the first surface; lower surface in FIG. 1; which may be referred to as a “rear surface”) of the base material 11 may preferably be 5 to 50 nm, and particularly preferably 10 to 30 nm. A maximum projection height (Rp) at the second surface of the base material 11 may preferably be 30 to 500 nm, and particularly preferably 50 to 300 nm.

If the arithmetic average roughness (Ra) of the second surface of the base material 11 is unduly small, the second surface will be excessively smooth, so that the second surface of the base material 11 and the highly smooth release agent layer 12 may closely contact to each other to readily cause blocking when the release film 1 is wound. If the arithmetic average roughness (Ra) of the second surface of the base material 11 is unduly large, it will be difficult to allow the maximum projection height (Rp) of the second surface of the base material 11 to fall within the above preferable range.

If the maximum projection height (Rp) at the second surface of the base material 11 is unduly large, the ceramic green sheet will be partially thin because the irregular profile of the second surface of the base material 11 in close contact with the ceramic green sheet may be transferred to the ceramic green sheet when the ceramic green sheet is wound after being molded. In this case, there may be a risk of troubles due to short circuit when those ceramic green sheets are laminated to manufacture capacitors. If the maximum projection height (Rp) of the second surface of the base material 11 is unduly small, the second surface of the base material 11 will have less irregularity so as to be flat, so that air may readily be involved into a surface at which the base material 11 contacts with a roll, such as during a process for forming the release agent layer 12. This may result in troubles such as that the base material 11 being carried meanders and winding deviation occurs when the base material is wound into a roll-shape.

When the arithmetic average roughness (Ra) and the maximum projection height (Rp) at the second surface of the base material 11 are adjusted within the above ranges, winding deviation at the time of winding can effectively be suppressed. Therefore, the winding tension need not be increased, and it is thereby possible to suppress the deformation of the core portion and its periphery due to the winding tension.

The same layer as the release agent layer 12 to be described later, or a different layer from the release agent layer 12, may be provided on the opposite surface to the first surface of the base material 11. In these cases, the second surface of the base material 11 refers to a surface at the opposite side to the base material 11 side among surfaces of these layers.

To obtain a film in which both of the maximum projection height (Rp) of the first surface of the base material 11 and the maximum projection height (Rp) of the second surface of the base material 11 are within the above preferable ranges, the base material 11 to be used may be such that the maximum projection height (Rp) of the first surface of the base material 11 and the maximum projection height (Rp) of the second surface of the base material 11 are different, i.e., the front and rear surfaces of different roughness degrees, or the base material 11 may be such that the maximum projection height (Rp) of the first surface and the maximum projection height (Rp) of the second surface are substantially the same, i.e., the front and rear surfaces of the same roughness degree.

The release agent layer 12 has a desired releasability. When the release agent layer 12 is laminated on the first surface of the above base material 11, the arithmetic average roughness (Ra) and the maximum projection height (Rp) at the surface of the release agent layer 12 can be within the previously-described ranges. The release agent layer 12 can be obtained by curing a release agent composition that contains: an active energy ray curable component; and a silicone-based component (the release agent composition is referred hereinafter to as a “release agent composition C”). According to the release agent composition C, the surface of the release agent layer 12 to be obtained can be highly smooth because recess portions that are present between the protrusions on the first surface of the base material 11 may be effectively filled mainly with the cured material of the active energy ray curable component. In addition, the surface of the release agent layer 12 can be imparted with appropriate releasability due to the silicone-based component or its cured material. Heretofore, it was necessary for a certain resin film, especially a polyester-based film, to add a filler material in order to obtain slipping property of the surface and/or mechanical strength. Thus, it was difficult to reduce the area occupation ratio of coarse protrusions at the surface due to the filler material. In contrast, the surface of the release agent layer 12 can be highly smooth due to the cured material of the active energy ray curable component as described above, and it is thereby possible to reduce the area occupation ratio of coarse protrusions at the surface of the release agent layer 12 to a restricted value.

The active energy ray curable component is not particularly limited as long as it does not hinder the effect of the present invention and it is a component that can be cured by irradiation of active energy ray. The active energy ray curable component may be any of a monomer, oligomer, polymer, or mixture thereof. This active energy ray curable component may preferably be (meth)acrylic ester. The (meth)acrylic ester as used herein means both acrylic ester and methacrylic ester. The same applies to other similar terms. When the main component of the release agent layer 12 is a cured material of (meth)acrylic ester-based component, repellency to the ceramic slurry may not be caused on the release agent layer 12.

The (meth)acrylic ester may preferably be at least one kind selected from polyfunctional (meth)acrylate monomers and (meth)acrylate oligomers, particularly preferably at least one kind selected from trifunctional or more functional (meth)acrylate monomers and (meth)acrylate oligomers, and further preferably at least one kind selected from trifunctional or more functional (meth)acrylate monomers. Being trifunctional or more functional allows the release agent composition C to have excellent curability and also allows the surface of the obtained release agent layer 12 to have more excellent releasability.

Examples of the polyfunctional (meth)acrylate monomer include 1,4-butanediol di(meth)acrylate, 1,6-hexanediol di(meth)acrylate, neopentyl glycol di(meth)acrylate, polyethylene glycol di(meth)acrylate, neopentyl glycol adipate di(meth)acrylate, hydroxypivalic acid neopentyl glycol di(meth)acrylate, dicyclopentanyl di(meth)acrylate, caprolactone-modified dicyclopentenyl di(meth)acrylate, ethylene oxide-modified phosphoric acid di(meth)acrylate, allylated cyclohexyl di(meth)acrylate, isocyanurate di(meth)acrylate, trimethylolpropane tri(meth)acrylate, dipentaerythritol tri(meth)acrylate, dipentaerythritol tetra(meth)acrylate, propionic acid-modified dipentaerythritol tri(meth)acrylate, pentaerythritol tri(meth)acrylate, propylene oxide-modified trimethylolpropane tri(meth)acrylate, tris((meth)acryloxyethyl)isocyanurate, propionic acid-modified dipentaerythritol penta(meth)acrylate, dipentaerythritol hexa(meth)acrylate, and caprolactone-modified dipentaerythritol hexa(meth)acrylate, among which dipentaerythritol hexa(meth)acrylate is preferable. These may be solely used, or two or more kinds may be used in combination.

Examples of the polyfunctional (meth)acrylate oligomer include polyester acrylate-based oligomer, epoxy acrylate-based oligomer, urethane acrylate-based oligomer, polyether acrylate-based oligomer, polybutadiene acrylate-based oligomer, and silicone acrylate-based oligomer.

The polyester acrylate-based oligomer can be obtained, for example, by using polyester oligomer which is obtained by condensation of polycarboxylic acid and polyalcohol and has hydroxyl groups at both ends and esterifying the hydroxyl groups with (meth)acrylic acid, or using oligomer obtained by addition of alkylene oxide to polycarboxylic acid and esterifying the hydroxyl groups at ends of the oligomer with (meth)acrylic acid.

The epoxy acrylate-based oligomer can be obtained, for example, by esterification of an oxirane ring of relatively low molecular weight bisphenol-type epoxy resin or novolak-type epoxy resin with (meth)acrylic acid. There may also be used carboxyl-modified-type epoxy acrylate-based oligomer which is partially modified epoxy acrylate-based oligomer with dibasic carboxylic acid anhydride.

The urethane acrylate-based oligomer can be obtained, for example, by esterifying polyurethane oligomer with (meth)acrylic acid. The polyurethane oligomer may be obtained by reaction of polyether polyol or polyester polyol and polyisocyanate.

The polyether acrylate-based oligomer can be obtained, for example, by esterifying hydroxyl groups of polyether polyol with (meth)acrylic acid.

The above polyfunctional (meth)acrylate monomers and polyfunctional (meth)acrylate oligomers may be used solely in one kind, or two or more kinds may be used in combination. One or more polyfunctional (meth)acrylate monomers and one or more polyfunctional (meth)acrylate oligomers may be used in combination.

The release agent composition C may include one of the active energy ray curable components solely, or two or more of them in combination.

The silicone-based component is not particularly limited as long as it does not hinder the effect of the present invention and it is a component that can impart desired releasability to the surface of the release agent layer 12. There may be used polyorganosiloxane, preferably polyorganosiloxane having a reactive functional group, and particularly preferably polydimethylsiloxane having a reactive functional group. When the polyorganosiloxane having a reactive functional group is used, irradiation of active energy ray or other reaction step (e.g., heating step) may cause the reactive functional group to react so that the polyorganosiloxane (silicone-based component) will be incorporated in the cross-linked structure and fixed. This suppresses the silicone-based component in the release agent layer 12 from transferring and migration to the ceramic green sheet molded on the release agent layer 12.

The reactive functional group may be introduced to one end or to each of both ends of polyorganosiloxane or to a side chain. Examples of the reactive functional group include (meth)acryloyl group, vinyl group, maleimide group, epoxy group, carboxyl group, isocyanate group, and hydroxyl group, among which (meth)acryloyl group, vinyl group and maleimide group are preferable because they can be cured concurrently with curing of the above active energy ray curable component (when active energy ray is irradiated). It may be preferable that at least two reactive functional groups are introduced in one molecule of polyorganosiloxane. Two or more kinds of these reactive functional groups may also be introduced in one molecule of polyorganosiloxane.

The release agent composition C may include one of the silicone-based components solely, or two or more of them in combination.

A mass fraction of the silicone-based component in the release agent composition C to a total mass of the active energy ray curable component and the silicone-based component may preferably be 0.7 to 5 mass %, and particularly preferably 1.0 to 2.5 mass %. By adjusting the mass fraction of the silicone-based component within the above range, ceramic slurry can be applied to the surface of the release agent layer 12 without being repelled, and the ceramic green sheet thus molded can readily be released without breakage, so that the release agent layer 12 has excellent releasability. If the mass fraction of the silicone-based component is less than 0.7 mass %, there may be a risk that the release agent layer 12 cannot exert sufficient releasing performance. If the mass fraction of the silicone-based component exceeds 5 mass %, there may be a risk that, when ceramic slurry is applied to the surface of the release agent layer 12, the ceramic slurry tends to be repelled. In addition, the release agent layer 12 will be difficult to be cured so that sufficient releasability may not be obtained.

The release agent composition C may include preferably 85 mass % or more of a mass fraction of the total mass of the active energy ray curable component and the silicone-based component to the whole mass of a solid content, and particularly preferably 90 mass % or more. When the total mass fraction of the active energy ray curable component and the silicone-based component is within the above range, the obtained release agent layer 12 has a highly smooth surface and the release agent composition C readily has a sufficient curability.

When ultraviolet ray is used as the active energy ray to irradiate the release agent composition C, it may be preferable that the release agent composition C further contains photopolymerization initiator. Containing the photopolymerization initiator may allow the active energy ray curable component (and the silicone-based component) to efficiently be cured; and may also reduce the time required for polymerization and curing, and the amount of irradiating light ray.

Specific examples of the photopolymerization initiator include benzophenone, acetophenones, benzoin, benzoin methyl ether, benzoin ethyl ether, benzoin isopropyl ether, benzoin isobutyl ether, benzoin benzoic acid, benzoin methyl benzoate, benzoin dimethyl ketal, 2,4-diethylthioxanthone, 1-hydroxycyclohexyl phenyl ketone, benzyl diphenyl sulfide, tetramethyl thiuram monosulfide, azobisisobutyronitrile, benzyl, dibenzyl, diacetyl, β-chloroanthraquinone, (2,4,6-trimethyl benzyl diphenyl)phosphine oxide, and 2-benzothiazole-N,N-diethyldithiocarbamate. In particular, preferable examples for an excellent surface curability include 2-hydroxy-1-{4-[4-(2-hydroxy-2-methyl-propionyl)-benzil]-phenyl}-2-methylpropane-1-one, 1-hydroxy-cyclohexyl-phenyl-ketone, 2-hydroxy-2-methyl-1-phenyl-propane-1-one, and 2-methyl-1-[4-(methylthio)phenyl]-2-morpholinopropane-1-one. Among which 2-hydroxy-2-methyl-1-phenyl-propane-1-one and 2-methyl-1-[4-(methylthio)phenyl]-2-morpholinopropane-1-one are particularly preferable. These may be solely used, or two or more kinds may be used in combination.

The photopolymerization initiator may preferably be used with an amount within a range of 1 to 20 mass parts, in particular 3 to 15 mass parts, to the total 100 mass parts of the active energy ray curable component and an active energy ray curable silicone-based component (e.g., polyorganosiloxane having (meth)acryloyl group or groups, vinyl group or groups or maleimide group or groups as reactive functional group or groups).

The release agent (including the release agent composition C) that constitutes the release agent layer 12 may contain, as necessary, silica, antistatic agent, dye, pigment and/or other additives. These additives may preferably be used with an amount within a range of 0.1 to 10 mass parts to the total 100 mass parts of the active energy ray curable component and the silicone component.

The thickness of the release agent layer 12 may preferably be 0.3 to 2 μm, and particularly preferably 0.5 to 1.5 μm. If the thickness of the release agent layer 12 is less than 0.3 μm, the smoothness of the surface of the release agent layer 12 will be insufficient, so that pinholes and/or thickness irregularity may readily occur in the ceramic green sheet. If the thickness of the release agent layer 12 exceeds 2 μm, there may be a risk that curling readily occurs in the release film 1 due to the cure shrinkage of the release agent layer 12. In addition, when the release film 1 is wound into a roll-shape, there may be a risk that winding failure is caused because blocking with the second surface of the base material 11 may readily occur and/or that the electrostatic charge amount increases at the time of unwinding so that foreign materials may easily be attached thereto.

The release agent layer 12 can be formed by: applying a releasing agent solution, which contains the releasing agent and desired diluent and other additives, to the first surface of the base material 11; drying it as necessary; and curing it using irradiation of an active energy ray. When the reactive functional group or groups of the silicone-based component are those which react by heat, the drying at that time may cause the reaction so that the silicone-based component can be incorporated in the cross-linked structure. Examples of application method of the releasing agent solution to be used include gravure-coating method, bar-coating method, spray-coating method, spin-coating method, knife-coating method, roll-coating method, and die-coating method.

As the active energy ray, there may ordinarily be used ultraviolet ray, electron ray or the like. The irradiation amount of the active energy ray differs depending on the type of energy ray, but may preferably be 50 to 1000 mJ/cm², and particularly preferably 100 to 500 mJ/cm² as an amount of light in a case of ultraviolet ray. In a case of electron ray, the amount may preferably be about 0.1 to 50 kGy.

The irradiation of the above active energy ray causes the active energy ray curable component in the release agent composition C to cure. When the silicone-based component in the release agent composition C has active energy ray curable reactive group or groups, the silicone-based component is also cured. This allows the release agent layer 12 to be formed which is highly smooth and unlikely to repel ceramic slurry and has excellent releasability of ceramic green sheet.

By using the release film 1 as described above, it is possible to effectively prevent/suppress the occurrence of defects such as pinholes and thickness irregularity in a ceramic green sheet to be obtained. Moreover, also when the ceramic green sheet is released from the release film 1, it is possible to effectively prevent/suppress the occurrence of troubles such as breakage of the ceramic green sheet.

It should be appreciated that the embodiments heretofore explained are described to facilitate understanding of the present invention and are not described to limit the present invention. Therefore, it is intended that the elements disclosed in the above embodiments include all design changes and equivalents to fall within the technical scope of the present invention.

For example, one or more other layers may be present between the base material 11 and the release agent layer 12 and/or on the second surface of the base material 11.

### EXAMPLES

The present invention will hereinafter be described further specifically with reference to examples, etc, but the scope of the present invention is not limited to these examples, etc.

### Example 1

A polyethylene terephthalate (PET) film (thickness of 31 μm) having front and rear surfaces of the same roughness degree was prepared as a base material. Both surfaces of this PET film have the arithmetic average roughness (Ra) of 29 nm and the maximum projection height (Rp) of 257 nm. Measuring method of the arithmetic average roughness (Ra) and the maximum projection height (Rp) at both surfaces of the PET film is the same as the measuring method of the arithmetic average roughness (Ra) and the maximum projection height (Rp) at the surface of the release agent layer to be described later (the same applies to the following examples).

The release agent composition C, comprising: 99.0 mass parts of dipentaerythritol hexaacrylate (A-DPH, solid content of 100 mass %, available from Shin Nakamura Chemical Co., Ltd.) as the active energy ray curable component; 1.0 mass part of polyether-modified acryloyl group-containing polydimethylsiloxane (BYK-3500, solid content of 100 mass %, available from BYK Japan KK) as the silicone-based component; and 5.0 mass parts of 2-methyl-1-[4-(methylthio)phenyl]-2-morpholinopropane-1-one (IRGACURE907 available from BASF) as the photopolymerization initiator, was diluted using a mixed liquid of isopropyl alcohol and methyl ethyl ketone (mixture mass ratio of 3:1), and the diluted solution was used as a release agent solution (solid content of 20 mass %). This release agent solution was applied to one surface (first surface) of the above base material using a bar coater so that the thickness of the release agent layer after curing would be 0.97 μm, and dried at 80° C. for 1 minute. Thereafter, ultraviolet ray was irradiated (accumulated light amount: 250 mJ/cm²) to cure the release agent composition C to form the release agent layer, and the film thus obtained was used as a release film. The thickness of the release agent layer is a result measured using a method of measurement to be described later (the same applies to the following examples).

### Examples 2 to 4

Release films were prepared in the same manner in Example 1 except that the obtained release agent layer had a thickness listed in Table 1.

### Examples 5 and 6

Release films were prepared in the same manner in Example 1 except that the release agent composition C contained the silicone-based component in the mass ratio listed in Table 1.

### Example 7

A PET film (thickness of 31 μm) having front and rear surfaces of the same roughness degree was prepared as a base material. At both surfaces of this PET film, the arithmetic average roughness (Ra) was 15 nm and the maximum projection height (Rp) was 98 nm. A release film was prepared in the same manner in Example 1 except that the above base material was used as a base material.

### Example 8

A release film was prepared in the same manner in Example 7 except that the release agent layer had a thickness listed in Table 1.

### Example 9

A PET film (thickness of 31 μm) having front and rear surfaces of different roughness degrees was prepared as the base material. At the first surface of this PET film, the arithmetic average roughness (Ra) was 7 nm and the maximum projection height (Rp) was 43 nm. At the second surface, the arithmetic average roughness (Ra) was 34 nm and the maximum projection height (Rp) was 250 nm. A release film was prepared in the same manner in Example 1 except that the above base material was used as a base material.

### Comparative Example 1

A release film was prepared in the same manner in Example 1 except that the release agent composition C did not contain a silicone-based component.

### Comparative Examples 2 to 4

Release films were prepared in the same manner in Example 1 except that the release agent layer had a thickness listed in Table 1.

### Comparative Example 5

A release agent solution having a solid content of 5.0 mass % was prepared by diluting 100 mass parts of a heat curable addition reaction-type silicone (KS-847H available from Shin-Etsu Chemical Co., Ltd.) using toluene and mixing thereto 2 mass parts of platinum catalyst (CAT-PL-50T available from Shin-Etsu Chemical Co., Ltd).

The release agent solution thus obtained was applied uniformly to one surface (first surface) of the same base material as that in Example 1 so that the thickness of the release agent layer to be formed after drying would be 0.3 μm, and dried at 140° C. for 1 minute to form the release agent layer. The film thus obtained was used as a release film.

### Comparative Examples 6 and 7

Release films were prepared in the same manner in Comparative Example 5 except that the release agent layer had a thickness listed in Table 1.

### Exemplary Test 1

### Measurement of Thickness of Release Agent Layer

The thickness (μm) of the release agent layer of the release film obtained in each of the examples and the comparative examples was measured using a reflective film thickness meter (F20 available from Filmetrics, Inc). Specifically, the release film obtained in each of the examples and the comparative examples was cut into 100×100 mm; the release film was then installed on the film thickness meter so that the opposite surface to a surface to be measured would be at the side of a suction stage; thicknesses were measured at ten locations at the surface of the release agent layer; and the average value was calculated as the thickness of the release agent layer. Results are listed in Table 1.

### Exemplary Test 2

### Measurement of Surface Roughness of Release Agent Layer

The release film obtained in each of the examples and the comparative examples was fixed to a glass plate via a double coated tape so that the opposite surface to a surface to be measured would be at the side of the glass plate. The arithmetic average roughness (Ra; nm) and the maximum projection height (Rp; nm) at the surface of the release agent layer of the release film were measured in conformity with JIS B0601-1994 using a surface roughness measuring machine (SV-3000S4, stylus type, available from Mitutoyo Corporation). Results are listed in Table 1.

### Exemplary Test 3

### Calculation of Area Occupation Ratio of Coarse Protrusions

There was measured an area occupation ratio of coarse protrusions having a projection height of 10 nm or more at the surface of the release agent layer of the release film fixed to a glass plate as in Exemplary Test 2. Specifically, the area occupation ratio of coarse protrusions was calculated such that: observation was performed at ×50 magnitude in PSI mode using an optical interferometry-type surface profile observation apparatus (WYKO-1100 available from Veeco Instruments Inc.); thresholding was performed between parts having a projection height of 10 nm or more and other parts in the obtained surface profile image within a coverage of 91.2×119.8 μm; and a percentage of a fraction of the obtained areas of parts having a projection height of 10 nm or more to the whole surface was calculated as the area occupation ratio (%) of coarse protrusions having a projection height of 10 nm or more. Results are listed in Table 1.

### Exemplary Test 4

### Evaluation of Curability of Release Agent Layer

For the release film obtained in each of the examples and the comparative examples, the surface of the release agent layer was polished reciprocally 10 times with a load of 1 kg/cm² using a waste cloth (BEMCOT AP-2 available from OZU CORPORATION) involving 3 ml of methyl ethyl ketone. Thereafter, the surface of the release agent layer was visually observed, and the curability of the release agent layer was evaluated in accordance with the following criteria:

A . . . There was no dissolution and dropping off of the release agent layer;

B . . . There was observed partial dissolution of the release agent layer; and

C . . . The release agent layer was completely dissolved and dropped off from the base material. Results are listed in Table 1.

### Exemplary Test 5

### Evaluation of Curling

The release film obtained in each of the examples and the comparative examples was cut into 200×200 mm and then placed on a flat glass plate so that the base material would be at the side of the glass plate. Subsequently, another glass plate of 100×100 mm was placed on the center of the release agent layer of the release film. Thereafter, a height from the upper surface of the lower glass plate to the top of each corner portion of the release film was measured and evaluated in accordance with the following criteria:

A . . . The sum of the heights of the corner portions was less than 50 mm;

B . . . The sum of the heights of the corner portions was 50 mm or more and less than 100 mm; and

C . . . The sum of the heights of the corner portions was 100 mm or more.

Results are listed in Table 1.

### Exemplary Test 6

### Evaluation of Blocking Property

The release film obtained in each of the examples and the comparative examples was wound up into a roll-shape having a width of 400 mm and a length of 5000 m. After this release film roll was kept under an environment of 40° C. and a humidity of 50% or less for 30 days, the appearance of the release film roll itself was visually observed, and the blocking property was evaluated in accordance with the following criteria:

A . . . There was no change from the time when the release film was wound up into a roll-shape (no blocking);

B . . . Change in color due to close contact between films was observed in a half region or less in the width direction (slight blocking occurred); and

C . . . Change in color due to close contact between films was observed over a half region in the width direction (blocking occurred).

Results are listed in Table 1.

### Exemplary Test 7

### Evaluation of Coating Ability of Slurry

Ceramic slurry was prepared by adding 135 mass parts of a mixed liquid of toluene and ethanol (mass ratio of 6:4) to 100 mass parts of barium titanate powder (BaTiO₃; BT-03 available from SAKAI CHEMICAL INDUSTRY CO., LTD), 8 mass parts of polyvinyl butyral (S-LEC B·K BM-2 available from SEKISUI CHEMICAL CO., LTD.) as binder, and 4 mass parts of dioctyl phthalate (dioctyl phthalate Cica first grade available from KANTO CHEMICAL CO., INC.) as plasticizer, and mixing and dispersing them using a ball mill.

The above ceramic slurry was coated on the surface of the release agent layer of the release film obtained in each of the examples and comparative examples across a width of 250 mm and a length of 10 m using a die coater so that the film thickness after drying would be 1 μm, and thereafter dried at 80° C. for one minute using a dryer. For the release film thus molded thereon with the ceramic green sheet, the whole surface of the coated ceramic green sheet was visually examined under fluorescent light illuminated from the side of the release film, and the coating ability of slurry was evaluated in accordance with the following criteria:

A . . . No pinhole occurred in the ceramic green sheet;

B . . . One to five pinholes occurred in the ceramic green sheet; and

C . . . Six or more pinholes occurred in the ceramic green sheet.

Results are listed in Table 1.

### Exemplary Test 8

### Evaluation of Releasability

A ceramic green sheet was molded on the surface of the release agent layer of the release film in the same procedure as that in Exemplary Test 7, and the ceramic green sheet was punched out into 200 mm×200 mm so that the release film would not be punched out. Subsequently, the sheet release mechanism of a green sheet laminator was utilized to suction the green sheet thus punched out onto a vacuum suction stage to release it from the release film. The releasability of the ceramic green sheet at that time was evaluated in accordance with the following criteria:

A . . . The ceramic green sheet was able to be smoothly released without break, and the ceramic green sheet did not remain on the release agent layer;

B . . . The ceramic green sheet was able to be released, but less smoothly, without being broken, and the ceramic green sheet did not remain on the release agent layer; and

C . . . The ceramic green sheet was broken, or was not able to be released.

Results are listed in Table 1.

### Exemplary Test 9

### Evaluation of Defects at Surface of Release Agent Layer

A coating liquid was prepared by dissolving a polyvinyl butyral resin into a mixed liquid of toluene and ethanol (mass ratio of 6:4). The coating liquid was coated on the release agent layer of the release film obtained in each of the examples and comparative examples so that the thickness after drying would be 1 μm, and dried at 80° C. for one minute to form a polyvinyl butyral resin layer. Thereafter, a polyester tape was laminated to the surface of the polyvinyl butyral resin layer.

Subsequently, the polyester tape was used to remove the release film from the polyvinyl butyral resin layer, and the number of recesses at the surface of the polyvinyl butyral resin layer that had been in contact with the release agent layer of the release film was counted.

Specifically, observation was performed at ×50 magnitude in PSI mode using an optical interferometry-type surface profile observation apparatus (WYKO-1100 available from Veeco Instruments Inc.); the number of recesses having a depth of 150 nm or more was counted on the basis of the obtained surface profile image within a coverage of 91.2×119.8 μm; and evaluation of defects at the surface of the release agent layer was performed in accordance with the following criteria:

A . . . The number of recesses was zero;

B . . . The number of recesses was 1 to 5; and

C . . . The number of recesses was 6 or more.

With regard to those of which the evaluation was “C” in the previously-described test for evaluation of releasability, this test was not performed because a sample sufficient to perform this test was not able to be obtained. Results are listed in Table 1.

If a capacitor is produced using a ceramic green sheet having recesses as above, the obtained capacitor will be such that a short circuit due to deterioration in withstanding voltage may readily occur.

TABLE 1

| | Thick- | Mass ratio | Surface roughness | | | | Area | | | | | | Evaluation |
|---|---|---|---|---|---|---|---|---|---|---|---|---|---|
| | ness of | of | (nm) | | | | occupation | | | | | | of defects |
| | release | silicone- | Surface of | | Rear surface | | ratio of | | | Evaluation | Evaluation | | at surface |
| | agent | based | release | | of base | | coarse | Evaluation | | of | of coating | Evaluative | of release |
| | layer | component | ager layer | | material | | protrusions | of | Evaluation | blocking | ability of | of | agent |
| | (μm) | (mass %) | Ra | Rp | Ra | Rp | (%) | curability | of curling | property | slurry | releasability | layer |
| Example 1 | 0.97 | 1.0 | 3 | 17 | 29 | 257 | 1.8 | A | A | A | A | A | A |
| Example 2 | 0.48 | 1.0 | 5 | 49 | 29 | 257 | 9.7 | A | A | A | A | A | A |
| Example 3 | 0.57 | 1.0 | 4 | 35 | 29 | 257 | 6.9 | A | A | A | A | A | A |
| Example 4 | 3.00 | 1.0 | 3 | 11 | 29 | 257 | 1.5 | A | C | A | A | A | A |
| Example 5 | 0.97 | 0.5 | 3 | 17 | 29 | 257 | 1.5 | A | A | A | A | B | A |
| Example 6 | 0.97 | 7.5 | 3 | 17 | 29 | 257 | 1.8 | C | A | B | B | B | A |
| Example 7 | 0.97 | 1.0 | 3 | 11 | 15 | 98 | 0.1 | A | A | A | A | A | A |
| Example 8 | 0.37 | 1.0 | 3 | 48 | 15 | 98 | 3.8 | A | A | A | A | A | A |
| Example 9 | 0.97 | 1.0 | 3 | 9 | 34 | 250 | 0.0 | A | A | A | A | A | A |
| Comparative | 0.97 | — | 4 | 19 | 29 | 257 | 2.1 | A | A | A | A | C | — |
| Example 1 | | | | | | | | | | | | | |
| Comparative | 0.10 | 1.0 | 13 | 147 | 29 | 257 | 21.1 | A | A | A | A | B | C |
| Example 2 | | | | | | | | | | | | | |
| Comparative | 0.20 | 1.0 | 11 | 102 | 29 | 257 | 15.5 | A | A | A | A | B | C |
| Example 3 | | | | | | | | | | | | | |
| Comparative | 0.25 | 1.0 | 9 | 62 | 29 | 257 | 12.8 | A | A | A | A | B | C |
| Example 4 | | | | | | | | | | | | | |
| Comparative | 0.30 | — | 29 | 241 | 29 | 257 | 18.9 | A | A | B | B | B | C |
| Example 5 | | | | | | | | | | | | | |
| Comparative | 0.60 | — | 26 | 219 | 29 | 257 | 16.5 | A | A | C | C | C | — |
| Example 6 | | | | | | | | | | | | | |
| Comparative | 1.00 | — | 24 | 202 | 29 | 257 | 14.8 | A | A | C | C | C | — |
| Example 7 | | | | | | | | | | | | | |

As apparent from Table 1, the release films obtained in the examples were such that no defect occurred due to the surface of the release agent layer and no defect occurred due to the rear surface of the base material, and had excellent releasability of ceramic green sheets.

### INDUSTRIAL APPLICABILITY

The release film for a ceramic green sheet production process according to the present invention is suitable for molding a thin film ceramic green sheet, in particular, having a thickness of 1 μm or less.

### DESCRIPTION OF REFERENCE NUMERALS

1 . . . Release film
11 . . . Base material
12 . . . Release agent layer

1. A release film for a ceramic green sheet production process, the release film comprising a base material and a release agent layer provided at one side of the base material, wherein
the release agent layer comprises a cured material of a release agent composition that contains an active energy ray curable component and a silicone-based component, and a surface of the release agent layer at an opposite side to the base material has an arithmetic average roughness (Ra) of 8 nm or less and a maximum projection height (Rp) of 50 nm or less.

2. The release film for a ceramic green sheet production process as recited in claim 1, wherein an area occupation ratio of coarse protrusions is 10% or less, wherein the coarse protrusions have a projection height of 10 nm or more at the surface of the release agent layer at the opposite side to the base material.

3. The release film for a ceramic green sheet production process as recited in claim 1, wherein the silicone-based component comprises polyorganosiloxane having a reactive functional group.

4. The release film for a ceramic green sheet production process as recited in claim 1, wherein a mass fraction of the silicone-based component in the release agent composition to a total mass of the active energy ray curable component and the silicone-based component is 0.7 to 5 mass %.

5. The release film for a ceramic green sheet production process as recited in claim 1, wherein the active energy ray curable component comprises (meth)acrylic ester.

6. The release film for a ceramic green sheet production process as recited in claim 5, wherein the (meth)acrylic ester comprises trifunctional or more functional (meth)acrylic ester.

7. The release film for a ceramic green sheet production process as recited in claim 1, wherein the release agent layer has a thickness of 0.3 to 2 μm.

8. The release film for a ceramic green sheet production process as recited in claim 2, wherein the silicone-based component comprises polyorganosiloxane having a reactive functional group.

9. The release film for a ceramic green sheet production process as recited in claim 2, wherein a mass fraction of the silicone-based component in the release agent composition to a total mass of the active energy ray curable component and the silicone-based component is 0.7 to 5 mass %.

10. The release film for a ceramic green sheet production process as recited in claim 2, wherein the active energy ray curable component comprises (meth)acrylic ester.

11. The release film for a ceramic green sheet production process as recited in claim 2, wherein the release agent layer has a thickness of 0.3 to 2 μm.

12. The release film for a ceramic green sheet production process as recited in claim 3, wherein a mass fraction of the silicone-based component in the release agent composition to a total mass of the active energy ray curable component and the silicone-based component is 0.7 to 5 mass %.

13. The release film for a ceramic green sheet production process as recited in claim 3, wherein the active energy ray curable component comprises (meth)acrylic ester.

14. The release film for a ceramic green sheet production process as recited in claim 3, wherein the release agent layer has a thickness of 0.3 to 2 μm.

15. The release film for a ceramic green sheet production process as recited in claim 4, wherein the active energy ray curable component comprises (meth)acrylic ester.

16. The release film for a ceramic green sheet production process as recited in claim 4, wherein the release agent layer has a thickness of 0.3 to 2 μm.

17. The release film for a ceramic green sheet production process as recited in claim 5, wherein the release agent layer has a thickness of 0.3 to 2 μm.

18. The release film for a ceramic green sheet production process as recited in claim 6, wherein the release agent layer has a thickness of 0.3 to 2 μm.
